(19) United States
(12) Patent Application Publication
(10) Pub. No.: US 2014/0010954 A1
(43) Pub. Date: Jan. 9, 2014

(54) Power Line Rider Applicator Tool

(71) Applicant: Robert Archer Hobson, III, Dallas, TX (US)

(72) Inventor: Robert Archer Hobson, III, Dallas, TX (US)

(21) Appl. No.: 13/932,961

(22) Filed: Jul. 1, 2013

Related U.S. Application Data
(60) Provisional application No. 61/668,362, filed on Jul. 5, 2012.

(51) Int. Cl. H02G 1/02; H04N 7/18

(52) U.S. Cl. CPC H02G 1/02; H04N 7/181
USPC 427/117; 118/307; 348/125

(57) ABSTRACT

A tool and method for assisting in the maintenance and inspection of power lines by providing a platform that rides along the power lines.

### PRIORITY

This application claims the benefit of Provisional Patent Application No. 61/668,362 (EFS:ID 13186125) filed on Jul. 5, 2012 by present inventor.

### BACKGROUND

1. Field of the Invention

This application relates to a tool that rides on power lines that can provide close access to the power lines to assist with maintenance jobs, applying chemicals and services to power lines and utility right of ways.

2.Description of Related Art

Performing service on power line networks is difficult and dangerous. Usually the power lines are energized and require careful attention as well as protective gear. It takes time to make the job safe and takes more time to perform the job. Jobs on power lines require the use of bucket trucks that raise the workers up to the power lines. The area of power lines that can be worked on is limited to the range of the bucket and arm attached to the truck below. Once the job is done on this section they must lower the bucket, take up the ground equipment and move to the next location. Jobs that require servicing long continuous miles of multiple lines would be inefficient and uneconomic and restricts or prevents the use of new technologies.

There are several reasons that power lines that are strung from pole to pole need to be accessed during their service lifetime. One reason could be to inspect the lines for damage or wear to better determine their useful service life. Another reason would be to apply chemical coatings that may increase the service life of the power lines by reducing damage to the lines from environmental factors. Another reason would be to apply chemicals to the area below the power lines to reduce vegetation in the right of way. Another reason would be to access vegetation that is overhanging the right of way. These are just some of reasons that personnel may need to have close access to power lines.

Therefore it would be advantageous to have a means of accessing the power lines remotely with a sturdy platform that would allow at least one of the above services to be performed with reduced risk to personnel. It would be further advantageous if the platform allowed for multiple services to be performed.

All references cited herein are incorporated by reference to the maximum extent allowable by law. To the extent a reference may not be fully incorporated herein, it is incorporated by reference for background purposes and indicative of the knowledge of one of ordinary skill in the art.

### BRIEF SUMMARY OF THE INVENTION

The problems presented in the field of power line maintenance and inspection are addressed by the systems and methods of the present invention. In accordance with one embodiment of the present invention, a remotely powered tool that rides along the power lines is provided. The tool rides along the tops of the power lines allowing the power lines to be positioned within a spray chamber in at least one embodiment such that the power lines may be coated with a spray on chemical Other uses and embodiments are further described.

Other objects, features, and advantages of the present invention will become apparent with reference to the drawings and detailed description that follow.

### BRIEF DESCRIPTION OF THE DRAWINGS

FIG. 1 is an isometric view of an embodiment of the invention;

FIG. 2 is a top view of the embodiment shown in FIG. 1;

FIG. 3 is a front view of the embodiment shown in FIG. 1;

FIG. 4 is a side view of the embodiment shown in FIG. 1;

FIG. 5 is a n isometric view of the floating wheel assembly of the embodiment shown in FIG. 1.

FIG. 6 is an isometric view of the rigid wheel assembly of the embodiment shown in FIG. 1;

FIG. 7 is an isometric view of the central platform of the embodiment shown in FIG. 1;

FIG. 8 is a cutaway view of a spray chamber of the embodiment shown in FIG. 1;

FIG. 9 is a front view of the spray chamber of the embodiment shown in FIG. 1;

FIG. 10 is an isometric view of another embodiment of the invention;

FIG. 11 is a top view of the embodiment shown in FIG. 10;

FIG. 12 is a front view of the embodiment shown in FIG. 10; and

FIG. 13 is a side view of the embodiment shown in FIG. 10.

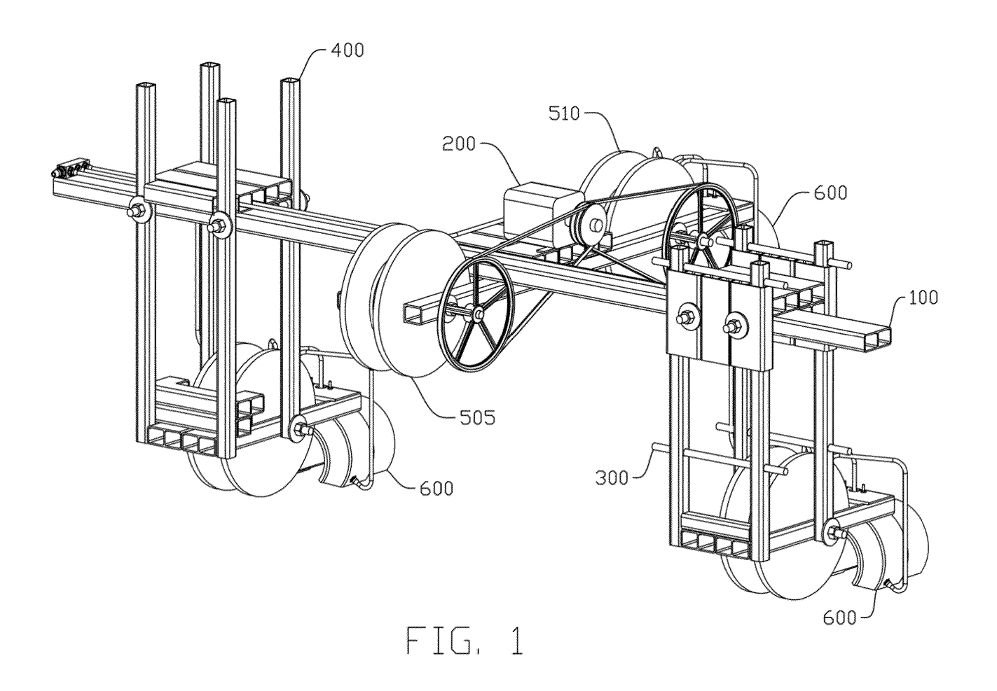

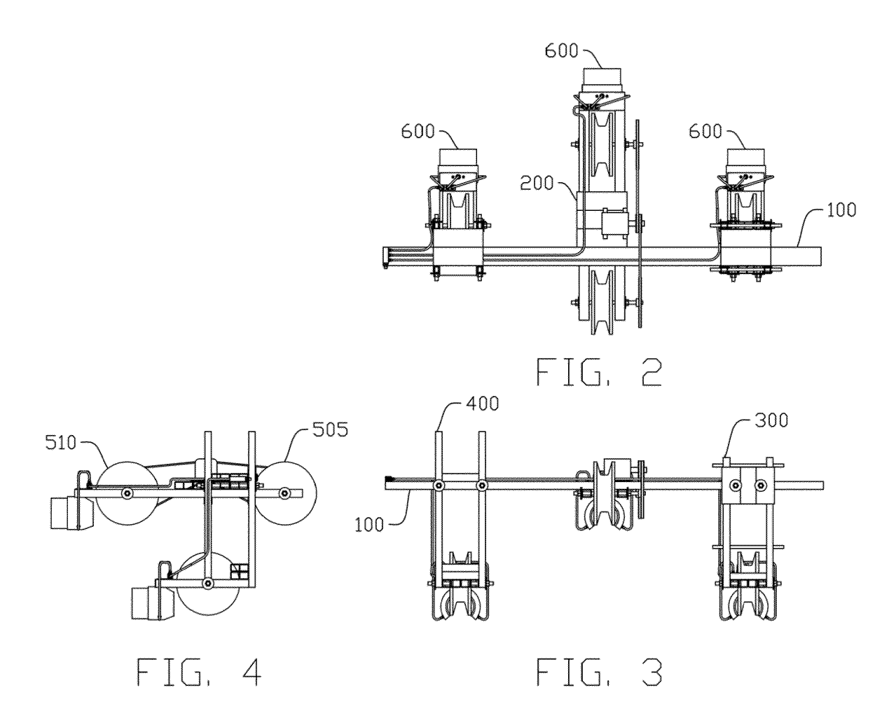

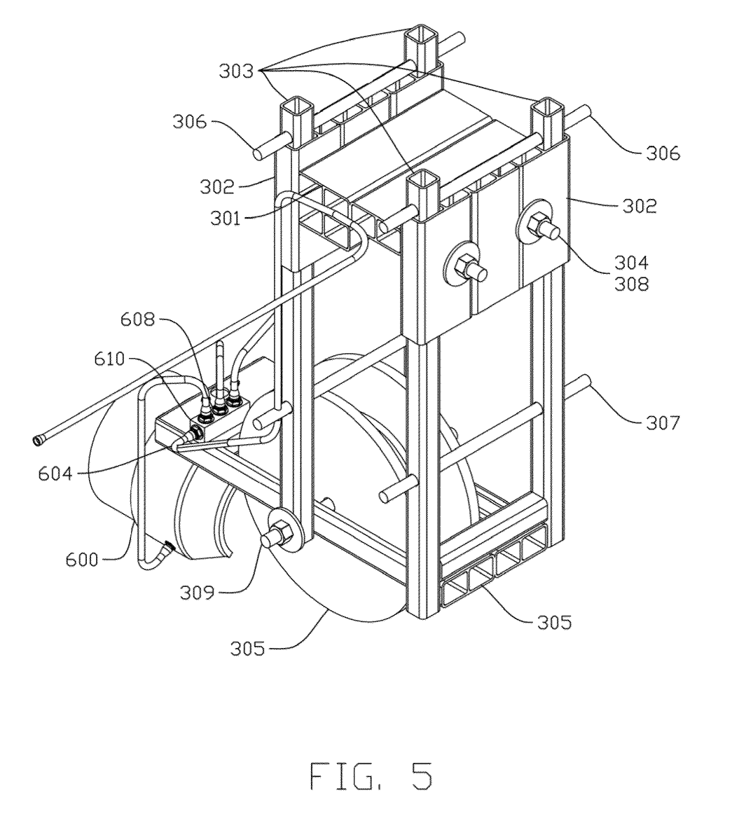

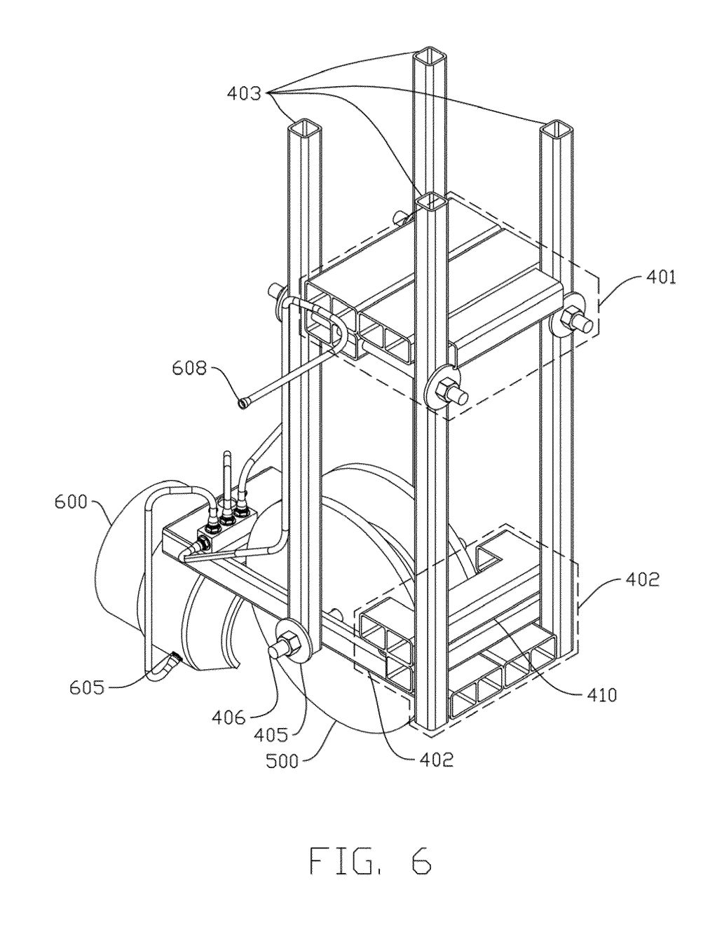

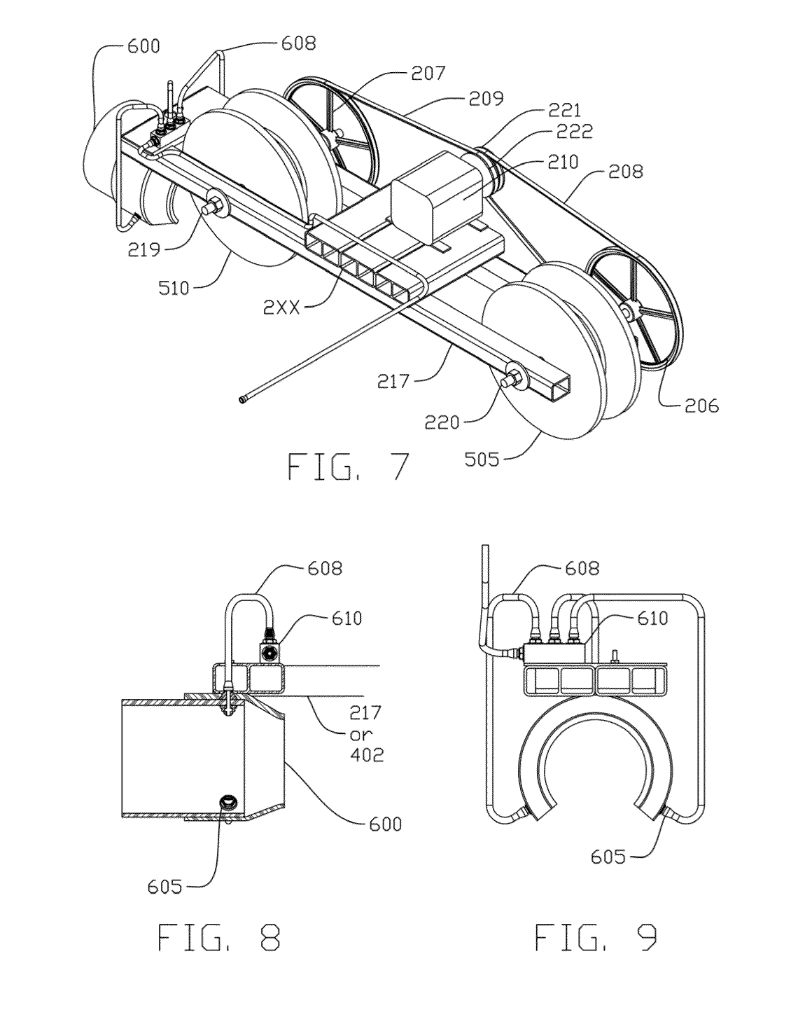

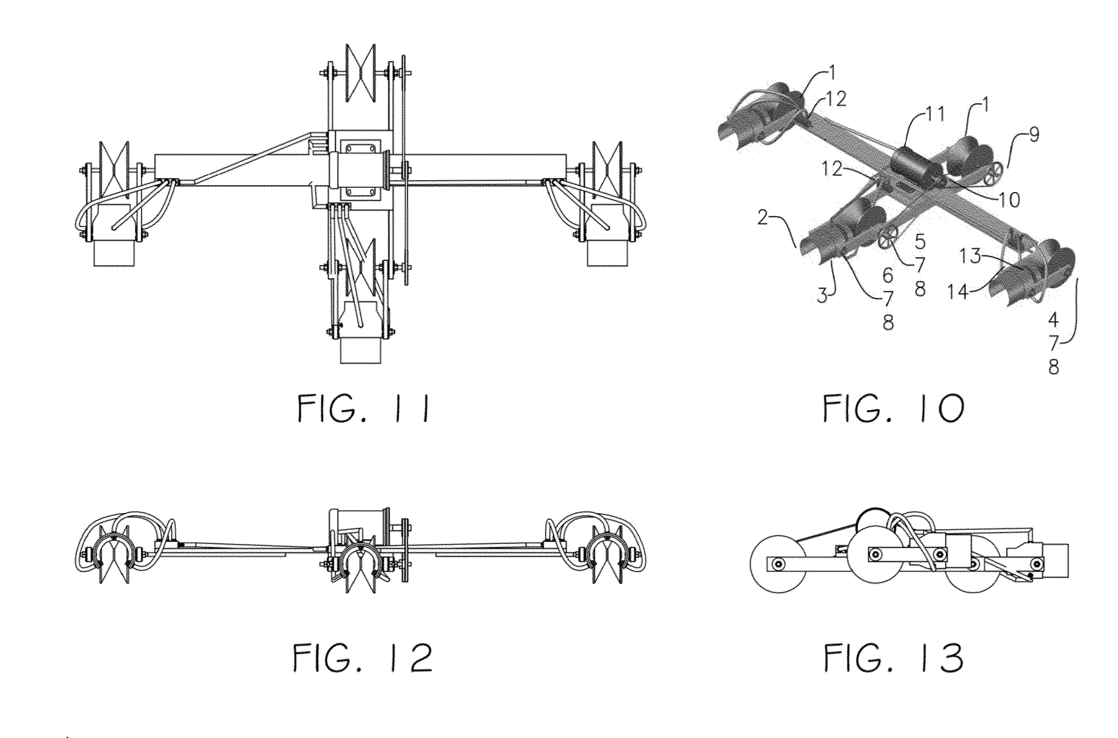

### DETAILED DESCRIPTION OF THE PREFERRED EMBODIMENT

All references cited herein are incorporated by reference to the maximum extent allowable by law. To the extent a reference may not be fully incorporated herein, it is incorporated by reference for background purposes and indicative of the knowledge of one of ordinary skill in the art.

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

The Power Tine Rider Applicator Tool (PLRAT) is a remote controlled self-powered mobile platform that is transported on concave wheels (500) over the power lines, energized and non-energized. The PLRAT rides on concave wheels (500) that hug, self track and follow the path of the power lines, and enable the PLRAT to ride over insulators on power poles. This devise can provide maintenance, spray protective coatings on power lines and insulators, clean insulators of contaminations, examine and video power lines for damage and faults, provide spray herbicide treatment for utility right of ways, and with attachments provide a platform to clear right of ways of overhanging brush and tree branches. It could also be used as a work platform for workers and equipment.

Overview

There are two main platforms, the center platform (200) and the cross arm (100) which attaches to the center platform (200) and provides a connection for attaching the outrigger wheel assemblies (300 & (400) and spray system chambers (600)

Cross Arm Platform (100)

The cross arm (100) is made from non-conductive structural material The cross arm (100) material has two hollow channels (102) that extend the length of the cross arm (100). The cross arm platform (100) is firmly attached to the center platform (200) and provides a platform for wheel assembly attachments (300 & 400) as well as other attachments. Wheel assemblies (300 & 400) can be attached to the cross arm (100) on either side of the central platform (200). The cross arm (100) provides a platform for other spray systems to be attached as well. It is attached securely to the top of the central platform (200) with bolts (101) and positioned so that it is toward the front of the central platform (200) so that the cross arm (100) can extend through the forward belt drive (208) and will not make contact with it. The cross arm (100) is positioned at a 90 degree angle to the central platform (200) on approximately the same horizontal plane.

The Main Manifold-Central Platform (215) is located at the end of the cross arm (100). Material supply hoses (608) and power hoes (608) travel within the cross arm channels (102).

The main manifold (215) is located and positioned on the top of the cross arm (100) at the end of the cross arm (100). This manifold (215) delivers material to hoses (608) that deliver the material to manifolds (610) on each spray chamber (200). Material supply is delivered to the main manifold (215) by hoses (608) from the mobile control unit by hoses (608).

Central Platform (200)

The center platform (200) is made of non-conductive fiberglass or teflon and has a front wheel (505) and back wheel (510) each centered between two extended arms (217 & 218) on each end of the central platform (200). These arms (217 &218) provide the structure to place an axel (219) for each wheel (505 & 510) both front and rear. Axel holes (220) are drilled on each arm (217 & 218)) at a point on the arm (217&218)) that will allow the wheel (505 & 510) to turn without contact to the central platform (200). The front and rear axels (219) are firmly attached to the wheel (505, 510) so that when the axel (219) turns so does the wheel (505 & 510). The axel (219) is positioned into one of the axel holes (405) on the front and rear wheels (505, 510). The other end extends through the opposite extended arm (217) of the central platform (200) so that a pulley (206 & 207) can be attached. A pulley (206 & 207) is attached to the end of each axel (219). A motor (210) is attached to the top of the central platform (200) equidistant from each wheel pulley (206 &207). A double groove pulley (221) is attached to the shank (222) of the motor and aligned to the wheel pulleys (206 & 207). Drive belts (208 & 209) are positioned into one of the two pulley (221) grooves on the motor pulley (221). These drive belts are then attached to front wheel pulley (206) and rear wheel pulley (207).

Motor-Central Platform (210)

The preferred motor (210) to drive the PLRAT is hydraulic. Hydraulic-motor power has the power to drive the PLRAT up the slump of power lines and over power poles. It also can provide the power to move the PLRAT up inclined power lines. Hydraulic power also allows the operator more control over speeds, forward and reverse, all of which can be controlled from the mobile control unit. Hydraulic hoses (608) originate from the mobile control unit and rise up to the end of the cross arm (100) where they are attached securely to the cross arm (100) and follow the cross arm (100) to the central platform (200) where they connect to the motor (210). It is possible that pneumatic power or electrical power could be used to drive the motor, but pneumatic power is more difficult to get sufficient torque and electrical power has control issues when in the proximity of the active power lines. The motor can controlled remotely to move the PLRAT forward or reverse.

Spray Chamber-Central Platform (600)

A spray chamber (600) is located and positioned at the rear of the center platform (200) behind the rear wheel (510). The spray chamber (600) is attached to the rear extended arms (218) so that the spray chamber (600) and spray nozzles (605) are aligned to the power line as it exits the rear wheel (510) The nozzles (605) extend through the wall of the spray chamber (600) and slightly into the spray chamber (600). They are located approximately 120 degrees arc apart from one another on different vertical planes on the interior spray chamber (600) walls. Their spray patterns coat the entire circumference of the power line as it travels through. The nozzles (605) are connected to hoses (608) that deliver material to the nozzles (605). There are separate hoses (608) that go to each nozzle (605). The other end of the each of these hoses (608) is connected to a manifold (610) located on the spray chamber (600) exterior surface. A supply hose (608) leads from this manifold (610) back to the main manifold (215) located on the cross arm (100).

Outrigger Wheel Assembly (300 & 400)

The outrigger wheel assemblies are made of non-conductive materials. There are two different outrigger wheel assemblies (300 & 400), the rigid wheel assembly (400) maintains constant contact with an outside target power line and the floating outrigger wheel assembly (300) which allows the wheel (500) attached to the lower part of the wheel assembly (300) to float, rise and tailing on the target outer line as power line slumps occur. The two wheel assemblies (300 & 400) can be placed on either side of the central platform (200) depending upon the choice of the control operator. The rigid assembly (400) is weighted and heavier than the floating assembly so that the imbalance will provide that the rigid assembly (400) will always ride on its target power line. The floating wheel assembly (300) on the opposite side will maintain contact with the power line under normal and standard configurations, but power lines are sometimes off horizontal planes when their support pole is not vertical or for other reasons. In this event, the floating assembly (300) will float on this line providing contact within the limits of the floating wheel assembly (300).

Floating Wheel Assembly (300)

The floating wheel assembly (300) is composed of the lower platform (305) that has four rods (303) rising vertically from the corners into enclosed channels (102) in the upper platform (310). These rods (303) are tree to rise and fell depending upon power line dictates within limits. The upward motion of the lower wheel platform (305) is limited by stops (307) placed in the rods (302) above the wheel (500). Stops (307) are placed at the top of these four rods (303) above the upper platform (310) and prevent the lower platform (305) from falling. This lower platform (305) also includes the wheel (500), axel (404) and spray chamber (600) and manifold (610); the upper platform (310) of the floating wheel assembly (300) is the attachment mechanism that is positioned and securely attached to the cross arm (100); The upper platform (310) is composed of vertically positioned channel (102) sections that are attached to the front of the cross arm and another attached vertically to the top and rear of the upper platform. They provide the channels that provide horizontal control of the rods (303) and allow the rods (303) to rise and fell with the lower platform (305) over a limited vertical range of motion. The tipper platform (310) attaches to the cross arm (100). Two bolts (308) and four nuts (304) tie and bind the upper platform (310) together and the four vertically place pieces (302) secure the upper platform (310) to the cross arm (100).

The upper platform (310) floating wheel assembly (300) is attached to the cross arm (100) in a vertical position on the cross arm (100). This will position the lower platform (305) wheel (500) to be aligned to the target power line. This upper floating wheel platform (310) is comprised of two long bolts (308) and four companion nuts (304), and three small sized sections of the same cross arm (100) material to comprise the horizontal platform (301) and four sections of the sized cross arm (100) material to comprise the front and back vertical platform (302) panel to control lateral motion of the wheel assembly (300).

The upper (310) and lower (305) wheel assembly platforms are constructed to conform to an approximate cage design with the rods. While the platforms are different physically the placement of the rods on the platforms is close to concurrent. The same material that has been used to build the cross arm (100) as has been used to construct both platforms (305 & 310).

The upper wheel assembly platform (305) on the floating wheel assembly (300) are assembled as follows. A material piece (301) of size is adjoined side of the cross arm (100) is placed side by side to one another. Vertical pieces (302) are positioned side by side on the horizontal pieces (301), so that two holes can be drilled through inner channels channels (102) of the vertical piece (302), into and through the horizontal piece (301), through the cross arm (100), and through the front vertical piece (302 on the other side. Bolts are now inserted through the vertical pieces (302), cross arm (100), horizontal piece (301) and another matching vertical piece (302), nuts (304) attached and tightened. The upper platform (310) is now attached to the cross arm (100). Additional bolts may be required to fully secure the platform but the channels (102) on the corners must remain open unobstructed to allow the rods (303) to be placed within. Rods (303) are inserted into the four corner channels (102). These four rods (303) attach to the corresponding the lower platform (305) below.

The lower wheel platform (305) resembles a fork head with four tines with the middle two missing or a square platform with two arms extended to the rear. The lower wheel platform (305) is constructed as follows: Two horizontal pieces (301 are fitted together with long arms (311) that provide the cavity for the wheel (500). The four rods (303 protruding from the upper platform (310) are attached to the lower platform (305) as follows; the front two rods (303) are attached to the front corners of the lower platform (305); the rear rods (303) have axel holes (220) drilled into them. The wheel axel (309) is placed on the outside of each the platform extended arms (311), matching axel holes (220) are drilled into the designated position on the extended arms (220). A wheel (500) is positioned on the axel within the wheel cavity. The wheel (500) is allowed lateral movement within the range of the extended arms (311). Stops are attached to either end of the axel to prevent axel (309) migration. The spray chamber is attached to the arms (311) so that the nozzles (605) within are aligned correctly to the power line as it exits the rear wheel (500).

Stops (307) are located above the lower wheel platform (305) on the rods (303) to prevent the lower wheel (500) from rising into the bottom of the upper platform (310) Stops (307) are also positioned at a selected location on the rods (303) above the upper platform (310).

Rigid Wheel Assembly (400)

The rigid wheel assembly (400) is a vertical cage with four vertical parallel support rods (403) that form the corners supports for the assembly (400). The rods (403) are attached to the upper platform (401) which is securely attached to the cross arm (100). These rods (403) also attach to and support the lower platform (402) that holds the axel (404), wheel (500) and spray chamber (600). The upper platform is connected firmly and directly to the cross arm (100). Horizontal pieces (301) are used to construct the platform. Two pieces (301) are attached side by side with one side having another piece (301) attached making it a double width. This platform (401) is now positioned and fitted onto the cross arm (100) Holes are drilled into the sides of the pieces through the cross arm (100). Holes are drilled at matching locations on the rods (303). The rods (403) are positioned on the front and rear and bolts (308) are inserted, nuts (304) attached and tightened with the rod (403) securing the upper platform (401) to the cross arm (100).

The lower wheel platform (402) is attached to the four rod (403) coming from the upper platform (401). The Rigid assembly lower platform (402) is nearly identical to the lower platform (305) on the floating wheel assembly (300). It has a front section of two joined pieces (301) with extended arms (311) that create the wheel cavity. The lower platform (402) is made up of pieces (407). These pieces (407) make up lower platform (402). The lower platform (402) is attached to the four rods (403) at the bottom of the rods (403). The front of this lower platform (402) is attached firmly and directly to the two front support rods (403) that are connected to the upper platform (401) on the front of the cross arm (100). The two rear rod (403) supports have axel holes (405) drilled through them at near the bottom or end so that an axel (404) can be positioned and fixed so that the lower platform (402) and spray chamber (600) will be approximately parallel to the upper platform (401). Axel holes (405) are drilled at the bottom of the rods (403) and matching holes are drilled into the lower platform's extended arms (4025). An axel (404) is positioned in these axel holes (405). A wheel (500) is loosely positioned on the axel (404) so that it can roll freely. The spray chamber (600) is connected to the extended arms (4025). The spray chamber (600) and nozzles (605) are aligned to the power line exiting the control platform's (200) rear wheel (510). Stops (406) are attached to the ends of the axel (404).

Spray Chamber 600

The spray chamber (600) is a plastic pipe with a linear opening along the bottom which allows the power line to enter and exit freely. The power line is guided into the middle of the chamber (600) so that nozzles (605) spray can perform effectively. This positioning of the power tine in the spray chamber (600) allows the nozzles (605) to spray from close position but not make contact with the incoming power line, providing an effective spray for coating the entire circumference of the power line.

Spray nozzles (605) are positioned on the spray chamber (605) by drilling holes in the spray chambers (600) wails and fitting the nozzle (605) though the hole and into the chamber. The nozzles (605) extend slightly into the spray chamber (600) approximately and are located approximately 120 arc degrees apart on the chamber (600) walls but on different vertical planes. I believe at this time the best and most efficient nozzle (605) arrangement is three spray nozzles (605) but further testing will discover if more will improve the procedure. These nozzles (605) are positioned as follows, and is the best I can determine at this time for effective spraying, one at the top spray downward from the spray chamber (600) onto the top of the power line, a second approximately 120 degrees around one side of the chamber (600) and in a different vertical plane, and a third placed approximately 120 degrees from each of the other two nozzles (605). This should provide a spray design that sprays the total 360 degree circumference of the power line as it passes through. Spray material hoses (608) connect to the nozzles (605) on the exterior of the spray chamber (600) surface. These hoses (608) connect to a manifold (610) that can be located on the exterior of the spray chamber (600). A spray material supply hose (610) leads from this manifold (610) to the main manifold (215) on the cross arm (100).

The wheels (500) on the center platform (200) and both outriggers (300 & 400) are the same. These wheels are similar to railroad wheels in that the railroad wheels are shaped to fit railroad tracks. On the PLRAT these wheels (500) interior concave hug the power line and trap it similarly to the action of railroad car wheels. The wheels (500) need to perform two functions: trap the power line within the sides of the wheel in a way that the power line cannot escape and be able to transport over power pole insulators. I believe that the approximate concave should match the shape of the power line but this design may need to be changed after further testing. This will change accordingly to different power pole insulators as will the width and circumference of the wheel itself. This concave design will allow the PLRAT to self-track and self-follow the power line. It will also self-position and guide the power line correctly into the spray chamber (600) as it travels along the center platform wheels (500) and climbs well as over the insulators on power poles. The outrigger wheels (500) are pre-positioned to align to their respective power line and will also follow their lines providing balance and stability. The wheels are made of non-conductive plastic with a tough urethane coating. Along the bottom or center of the wheel's concave design, rubber strapping has been attached. The rubber strapping provides more traction and durability.

Supply and power lines: Lines delivering power to the motor are all dielectric. Supply lines supplying material to the sprayers are dielectric. All lines leading to the PLRAT that connect to the motor and material manifolds are securely attached to the cross arm as they extend to the end of the cross arm so not to interfere with operations. At the end of the cross arm they are firmly attached as they then extend downward to the mobile control and supply unit.

Additional Functions

The above Power Line Rider Applicator Tool (PLRAT) description focuses upon the service of spraying coatings on power lines but the tool can be modified to perform other important services and functions on power lines.
Herbicide treatment of power line rights of way: Sprayers can be located along the cross arm to treat vegetation issues more efficiently
Cameras can be attached to video and photograph power lines are they travel through the wheels
Cutting tools could be attached to the cross arm and powered by onboard motors that would cut overhanging brush and tree in the right of way.
Larger platforms could allow for work personnel, equipment and material to be transported over the power lines.

How to Use: The PLRAT must initially be placed on the power lines by using a bucket truck. Once the PLART has been placed on the lines correctly the tool motor can be energized and put the PLART in motion. It can continue on this power line configuration until the power line configuration changes or some other obstacle prevents it from following the power line track, then it must be removed from the power line with use of personnel and a bucket truck and repositioned.

Spraying functions on the tool are controlled by the mobile control unit accompanying the tool along the right of way. Equipment on the mobile control unit can initiate speed control as wed as intermittent or continuous spraying.

The PLRAT is made from non conductive materials such as fiberglass and Teflon and all hoses and lines connecting the PLRAT are dielectric, as well as the materials flowing in the hoses. The hose sizes are usually ¼″ hoses to supply material and power. Depending upon the function of the PLRAT the normal number of hoses leading from the mobile control unit to the PLRAT will be three.

Nozzles (605) are positioned in the wails of the spray chamber (600). These nozzles (605) are positioned at approximately 120 degree arc from each other on different vertical planes. The nozzles (605) extend through the wall of the chamber (600) and approximately ⅜″ into the chamber (600). Hoses (608) attached to the three nozzles (605) lead back to a manifold (610) positioned on the spray Chamber (600) surface. Hoses (608) lead from this manifold (610) back to the main manifold (215) on the Central platform (200).

The motor (210) that drives the PLRAT is hydraulic and the hydraulic lines (212) leading to and from the motor (210) follow the cross arm (100) to the end then descend to the mobile control unit nearby. The motor (210) can be controlled to go forward of backward depending upon the operator.

In addition hoses (212) connect the PLRAT to the traveling ground control unit. The mobile control ground unit supplies control of the PLRAT as well as supplies of materials to the spray nozzles (605) located on the spray chambers (600). The mobile control unit can also provide power to the PLRAT not only to run the motor (210) for transport but for other functions such as cutting overhanging trees and vegetation in rights of way. These hoses (212) can deliver the power to the onboard motor to drive the PLRAT but also provide power to runs other equipment on the PLRAT that would power other onboard equipment, facilitate maintenance, support as well as examination of many miles of power line. Additional spraying systems could be attached that would enable the tool to spray vegetation in the rights of way. Cutting tools could be attached as well and powered by onboard motors to control overhanging brush and trees foliage.

### INDEX

Cross Arm 100
Cross Arm Bolts 101
Cross Arm Channels 102
Central Platform 200
Pulley front wheel 206
Pulley Rear Wheel 207
Drive Belt Front 206
Drive Belt Rear 209
Motor 210
Hydraulic Hoses 212
Main Manifold 215
Center Platform Arms Front 217
Center Platform Arm Rear 218
Axel 219
Double groove pulley 221
Motor Shank 222
Floating Wheel Assembly 300
Horizontal channel material 301
Vertical channel material 302
Rods 303
Nuts 304
Lower platform 305
Upper stops 306
Lower stops 307
Bolts 308
Axel 309
Upper platform 310
Wheel outrigger 500
Rear Wheel 510
Front Wheel 505
Extended arms lower platform 311
Rigid Wheel Assembly 400
Upper wheel platform 401
bower wheel platform 402
Rods 403
Wheel Axel 404
Wheel Axel hole 405
Axel Stops 406
Sized pieces of Cross arm 407
Bolt 408
Nuts 409
Support 410
Wheels 500
Spray Chamber 600
Nozzles 605
Supply Hose 608
Manifold 610
Wheel 1
Spray Chamber, rear section 2
Spray Chamber, front section 3
Axels 4,5
Bolt 6
Nut 7
Washer 8
Center Hub 9, 10
Motor 11
Valves 12
Spray chamber 13
Sprayer Hoses 14

I claim:

1. A tool for maintaining or inspecting a three wire power line comprising:
a central platform, the central platform having a motor and two wheels, the wheels being substantially bi-conical and each wheel, being driven by the motor;
a cross member extending laterally from the center platform;
at least one wheel assembly attached to the cross member, the wheel assembly including at least one wheel;
a spray chamber attached to the center platform and a spray chamber attached to each wheel assembly, each spray chamber aligned with at least one wheel.

2. The tool of claim 1 wherein:
the motor is attached to the wheels on the central platform by a belt and pulley system.

3. The tool of claim 1 wherein:
the motor is a hydraulically driven motor attached to a hydraulic line that leads to a hydraulic pump remote from the tool.

4. The tool of claim 1 wherein:
at least one of the wheel assemblies is adjustable to allow for variance in the power line levels.

5. The tool of claim 1 wherein:
the spray chambers have a plurality of spray heads to allow for the application of a chemical coating onto the power lines, the spray heads being connected to a supply hose that leads to a remote supply of chemicals to be sprayed through the spray heads.

6. The tool of claim 1 wherein:
the spray chamber have a plurality of cameras allowing for the inspection of a power line as it passes through the spray chambers.

7. A method of providing a coating on power lines, the method comprising:
providing a power line riding tool with a plurality of wheels, a motor attached to at least one of the wheels, and spray chambers, each spray chamber having spray heads and being aligned with at least one wheel;
providing a remote power source to the motor;
providing a remote supply of chemicals to the spray heads;
positioning the tool on the power lines;
power in the motor to drive the tool along the power lines;
powering the chemical supply as the tool drives along the power lines to apply the chemical to the power lines within the spray chambers;
driving the tool over power fine supports that support the lines from below.

8. The method of claim 7 further comprising:
providing a power line riding tool that has an adjustable wheel assembly to allow for variances in the power lines.

9. A method of inspecting power lines, the method comprising:
providing a power line riding tool with a plurality of wheels, a motor attached to at least one of the wheels, and spray chambers, each spray chamber having cameras and being aligned with at least one wheel;
providing a remote power source to the motor;
positioning the tool on the power lines;
power in the motor to drive the tool along the power lines;
powering the cameras as the tool drives along the power lines to inspect the power lines within the spray chambers;
driving the tool over power line supports that support the lines from below.

10. The method of claim 9 further comprising:
providing a power line riding tool that has an adjustable wheel assembly to allow for variances in the power lines.
